(19) United States
(12) Patent Application Publication
(10) Pub. No.: US 2003/0195768 A1
(43) Pub. Date: Oct. 16, 2003

(54) Surgery center with a matrix of flow patterns and interaction nodes

(76) Inventor: Wade C. Taylor, Wauwatosa, WI (US)

Correspondence Address: Lisa A. Brzycki, GEHRKE & ASSOCIATES, S.C., 610 North 77th Street, Wauwatosa, WI, 53213, US

(21) Appl. No.: 10/121,132

(22) Filed: Apr. 11, 2002

(51) Int. Cl. G06F 17/60

(52) U.S. Cl. 705/2

(57) ABSTRACT

A surgery center includes a matrix of flow patterns and interaction nodes that are optimized by providing a physical structure that includes an admit/reception node, a pre-operative node, a surgical node, an acute recovery node and an observation node. The pre-operative node is located adjacent the admit/reception node. The surgical node is located adjacent the pre-operative node. The acute recovery node is located adjacent to the surgical node and between the surgical node and the observation node. The patient flow throughout each of the nodes is unidirectional. An instrument flow is circular and confined to the surgical node, a staff/physician flow includes a separate entry to the surgery center separate from the admit/reception node and the observation node, a supply flow is linear, and an environmental waste flow includes transitioning between a sterile zone and a non-sterile zone. The patient flow, the instrument flow, the staff/physician flow, the supply flow and the environmental waste flow intersect at the surgical node.

### BACKGROUND OF THE INVENTION

1. Field of the Invention

This invention relates to a surgery center that optimizes flow patterns by integrating them into a combination of nodes representing general areas (admit, pre-operative, surgical, acute recovery, and observation).

2. Discussion of the Prior Art

Good ambulatory surgery center design is not based on clever schemes developed over the centuries by gifted architects and planners. Good surgery center design is based on a rudimentary understanding of the absolute nature of the significant circulation patterns and the activities that occur within the created space.

Although an architect Louis Sullivan coined the phrase “form follows function” in the late 19th century, the concept applies to the design of surgery centers today. Today ambulatory surgery centers are still being designed without the fundamental understanding of the actual process of surgery, which results in the inefficient and costly facilities that are being built.

In 1972, the first surgery center was built in Phoenix, Ariz. Thirty years later, there are almost 3,000 surgery centers in the United States and this number is increasing rapidly.

The concept of a surgery center was developed when certain visionary healthcare providers realized that many outpatient procedures simply did not require the sophisticated hospital setting. It was realized that the same level of service (and in many instances better service) could be provided at a reduced cost using a surgery center. Many years later, the post-operative benefits for the patient began to surface. It was at this time that there was a paradigm shift in the perception of healthcare. Surgery centers represent elective healthcare and healthy patients.

It was not long before investors and surgeons alike were convinced of the benefits of a surgery center (better patient care at a better price). However, as healthcare costs continue to rise, it is paramount to the survival of the surgery center to build centers that result in efficient operation to reduce costs. Unfortunately, the surgery centers being built today are not based on a fundamental recognition that certain flow patterns are universal and ultimately dictate the final design of the surgery center.

What is needed, therefore, is a surgery center that identifies the major flow patterns and the interaction nodes, and optimizes these flow patterns to reduce costs.

### SUMMARY OF THE INVENTION

The present invention is directed to a surgery center including an admit/reception node, a pre-operative node located adjacent the admit/reception node, a surgical node located adjacent the pre-operative node, an acute recovery node located adjacent to the surgical node, and an observation node, wherein the acute recovery node is located between the surgical node and the observation node. A patient flow throughout each of the nodes is unidirectional, an instrument flow is circular and confined to the surgical node, a staff/physician flow includes a separate entry to the surgery center separate from the admit/reception node and the observation node, a supply flow is linear, and an environmental waste flow includes transitioning between a sterile zone and a non-sterile zone.

According to another aspect of the invention, a surgery center includes an admit/reception node, a pre-operative node located adjacent the admit/reception node, a surgical node located adjacent the pre-operative node, an acute recovery node located adjacent to the surgical node, and an observation node, wherein the acute recovery node is located between the surgical node and the observation node. A patient flow throughout each of the nodes is unidirectional.

According to yet a further aspect of the preferred embodiment of the present invention, a surgery center includes an admit/reception node, a pre-operative node located adjacent the admit/reception node, a surgical node located adjacent the pre-operative node, an acute recovery node located adjacent to the surgical node, and an observation node, wherein the acute recovery node is located between the surgical node and the observation node. A patient flow throughout each of the nodes is unidirectional, an instrument flow is circular and confined to the surgical node, a staff/physician flow includes a separate entry to the surgery center separate from the admit/reception node and the observation node, a supply flow is linear, an environmental waste flow includes transitioning between a sterile zone and a non-sterile zone. The patient flow, the instrument flow, the staff/physician flow, the supply flow and the environmental waste flow intersect at the surgical node.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is an illustration of the integration of flow patterns and interaction zones in a surgery center according to the present invention;

FIG. 2 is an illustration of unidirectional patient flow in a surgery center according to the present invention;

FIG. 3 is an illustration of interaction between the patient and the family in a surgery center according to the present invention;

FIG. 4 is an illustration of observation cubicles in a surgery center according to the present invention;

FIG. 5 is an illustration of substerile rooms adjacent operating rooms in a surgery center according to the present invention;

FIG. 6 is an illustration of an instrument flow pattern in a surgery center according to the present invention;

FIG. 7 is an illustration of an instrument flow pattern between soiled receiving/sterile processing and the operating room in a surgery center according to the present invention;

FIG. 8 is an illustration of a corridor to allow ambulatory patients to bypass a pre-operative node in a surgery center according to the present invention;

FIG. 9 is an illustration of a pre-operative node with curtains in a surgery center according to the present invention;

FIG. 10 is an illustration of a pre-operative node with walls in a surgery center according to the present invention;

FIG. 11 is an illustration of a separate counseling room adjacent the surgical node in a surgery center according to the present invention;

FIG. 12 is an illustration of cubicles to reduce sound in a surgery center according to the present invention;

FIG. 13 is an illustration of patient lockers in a surgery center according to the present invention;

FIG. 14 is an illustration of procedures in a surgical node in a surgery center according to the present invention;

FIG. 15 is an illustration of a surgery center according to the present invention.

### DETAILED DESCRIPTION OF THE PREFERRED EMBODIMENTS

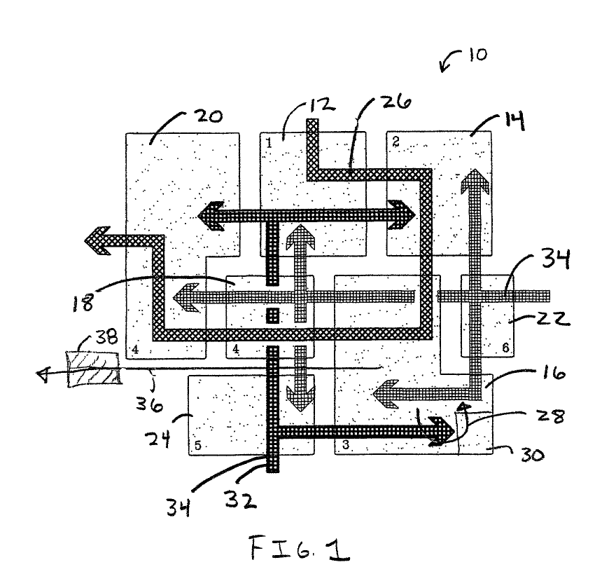

Referring initially to FIG. 1, a surgery center 10 includes an admit/reception node 12, a pre-operative node 14, a surgical node 16, an acute recovery node 18 and an observation node 20. A mechanical node 22 and a supply/utility node 24 may also be provided. Pre-operative node 14 is located adjacent admit/reception node 12, surgical node 16 is located adjacent pre-operative node 14, acute recovery node 18 is located adjacent to surgical node 16 between surgical node 16 and observation node 20.

A patient flow 26 throughout each of the nodes 12, 14, 16, 18 and 20 is unidirectional. An instrument flow 28 is circular, confined to surgical node 16 and flows through a series of substerile rooms 30. A staff/physician flow 32 includes a separate entry 34 to surgery center 10 separate from admit/reception node 12 and observation node 20. A supply flow 34 is linear, and an environmental waste flow 36 includes transitioning between a sterile zone and a non-sterile zone through a soiled holding area 38.

Patient flow 26, instrument flow 28, staff/physician flow 32, supply flow 34 and environmental waste flow 36 intersect at surgical node 16.

### Major Flow Patterns

I. Patient Flow

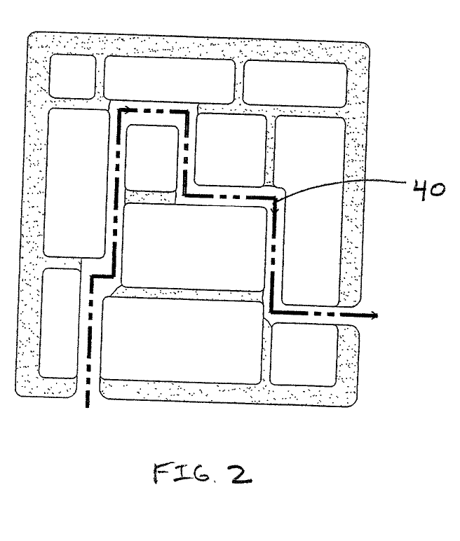

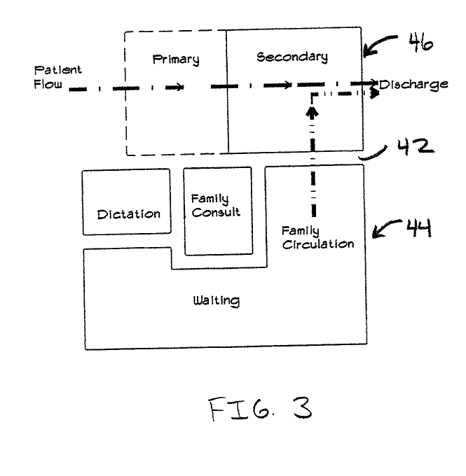

Patient flow 26 is perhaps the most critical of the patterns. Patient flow 26 is optimized in a unidirectional pattern. The patient flow will dictate the management of the four remaining flow patterns. Patient dignity is paramount. Not allowing switchbacks or parallel patient patterns will accomplish this goal. As illustrated in FIG. 2, a circular pattern 40 functions whereas a linear pattern does not, because, inevitably patients are brought to the surgery center by a family member or sponsor and must meet with them at the end of the cycle. A circular pattern meets the dignity factor without requiring the sponsors to navigate the clinical elements of the center. As illustrated in FIG. 3, a short corridor or passageway 42 between a waiting area 44 and a step-down recovery area 46 reduces sponsor circulation. Separate entry and discharge located within reasonable proximity enhances the design.

Typically, a unidirectional pattern will require more functional space and subsequently a larger facility. The circular flow is designed on the foundation that timing and functional relationships coexist as antagonistic or obliging. The challenge is to maximize the efficiency of the facility (smaller spaces and better functional relationships) without sacrificing the integrity of unidirectional patient flow 26.

II. Staff and Physician Flow

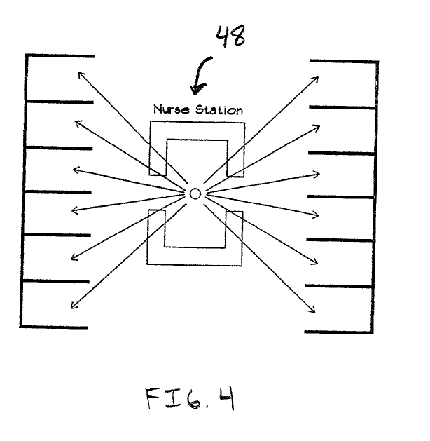

The function of the staff is to support the physicians in the process. Staff has two categories, administrative and clinical. The staff and physicians interact with the patient along the patient circulation pattern at significant junctures. This inherently creates a second pattern known as the staff and physician flow pattern 32. Staff/physician flow 32 requires some discretion in and of itself. A separate entry to the facility is important to allow movement without potential engagements by curious sponsors. The patient and administrative staff interact briefly at the beginning of the pattern. After leaving the public area clinical staff meets, greets and escorts patients through the facility. As illustrated in FIG. 4, the staff must have a central control area 48 for delegating and supervising activities. Control area 48 is optimum if it is located at the epicenter of patient flow pattern 26. This reduces staff circulation and increases staff/patient interaction.

The physicians must have access to patients before and after surgery. The activities of pre-operative discussion, surgery, dictation, family debriefing and discharge must be efficient for the surgeon. This will maximize the timing of actual procedures and operating room turn around time. A well-ordered circulation pattern for the physician will permit five to ten minute room turnaround times. The physician must be able to successfully conduct his pre and post operative activities during the turn around time allotted. This pattern is more radial in nature with the operating room as the epicenter.

III. Instrument Flow

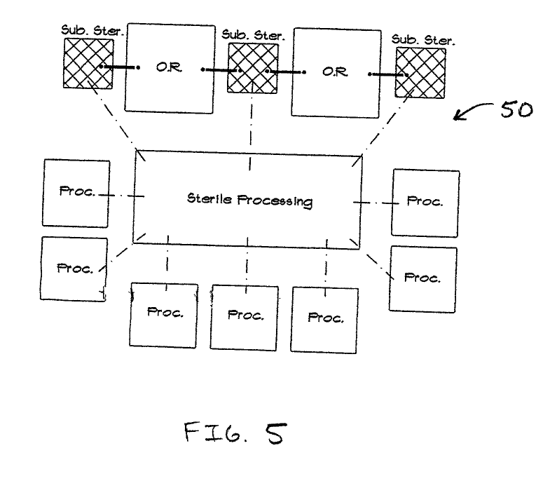

The flow of instruments 28 is dictated by the need for sterilization. As illustrated in FIG. 5, the most effective pattern eliminates the incidence of soiled and sterile instruments in the same location. A centralized soiled receiving and clean supply area 50 maximizes instrument flow. The importance of this pattern is magnified when considering the blood borne and air borne pathogens that can infect staff and patients.

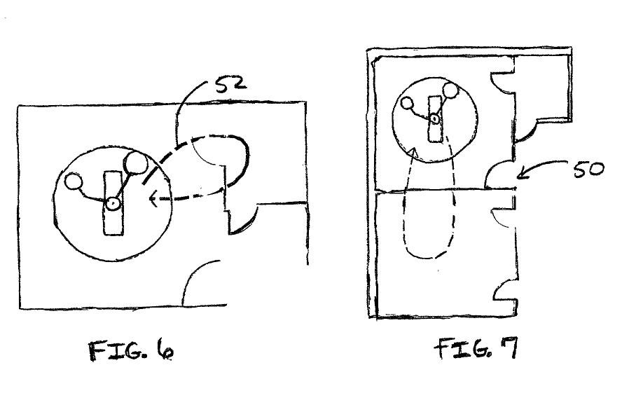

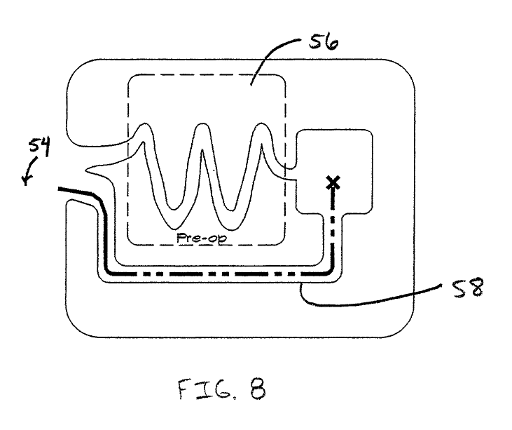

Instrument flow 28 needs to be circular and confined to surgical node 16. As illustrated in FIGS. 6 and 7, due to the inherent possibility of human error, the process of instrument sterilization is heavily regulated. Instrument flow 28 is least affected by patient flow 26. Instruments are used on one patient at a time before being terminally sterilized. Instruments soiled during a surgical procedure can be flash sterilized using flash flow 52 and used again on the same patient. The location of soiled receiving area and the clean supply area 50 will dictate the amount of time required for both flash sterilization and terminal sterilization. Flash sterilization is a sub-pattern to terminal sterilization. Flash and terminal sterilization require specific processing times that cannot be shortened for efficiency. Proper space adjacencies and circulation areas create efficiencies.

IV. Supply Flow

Supply flow 34 is linear. The delivery for supplies should be separate from the patient entry, but can share the staff/physician entry. Supplies are medical or administrative. Vehicles of various sizes deliver the supplies. A loading zone is best located nearest the medical gas supply room. Medical gas tanks are heavy and cumbersome. The floor finishes can be damaged after prolonged exposure to the movement of gas tanks. Tank delivery can be timed to avoid heavy patient use of the facility. Only administrative supplies should arrive through the front patient entry.

Medical supplies should be delivered to a designated Receiving room that is on an exterior wall adjacent to a loading zone. Medical supplies must be removed from the cardboard cartons prior to storage in the adjacent Bulk Supply room. The Bulk Supply room is the epicenter of the medical supplies. The room must be accessible to receiving, sterile processing and the non-sterile area simultaneously. The positioning of the supply room is critical to the efficiency of dispersing supplies. Supplies must be taken to several sterile and non-sterile areas.

V. Environmental Waste Flow

Environmental waste flow 36 is from sterile to non-sterile. Blood by-products on instruments and accessories (gauze pads, linens, etc.) must be processed and removed from the facility with minimal exposure to the sterilized environment. These items are packaged in designated containers and removed by a specialized, authorized company. Temporary storage must be provided for the environmental waste. A storage area labeled Soiled Holding needs to be adjacent to the clean corridor but not in the clean corridor. The optimum location for this storage area is between the clean corridor and an exterior wall. This allows for an exterior door for access to the waste without traversing the sterilized environment. Locating environmental waste receptors in certain clinical areas creates a sub-pattern. At specific times, this waste is packaged and relocated to the central Soiled Holding area for pickup and removal.

### Integration of Flow Patterns

Based on the key attributes of each of the five flow patterns discussed above, the preferred embodiment of the present invention integrates these patterns with primary nodes. Each pattern is evaluated for its efficiency of the center.

Patient flow 26 is the primary pattern to which the other four flow patterns 28, 32, 34 and 36 are secondary. Given this arrangement, certain interactive nodes are identified along the primary pattern. These interactive nodes have a specific function of time and procedure. Once identified, these nodes are examined and integrated with the flow patterns.

I. Admit/Reception Node

The first node is the admit/reception node 12. The activities are characterized by greetings, signing of waivers or reports and occasionally education. Upon arriving at the center, a patient experiences anxiety. It is critical that this anxiety be addressed immediately. Architectural responses such as pleasant surroundings, aquariums and sophisticated lighting are effective in reducing pre-surgery anxiety. The disposition of the greeting staff member is important in order to establish immediate recognition of the individual. This interactive node sets the stage for the remainder of the patient's visit.

The length of time for this node of interaction is dynamic. The required pre-testing and questioning must be performed in order to ensure safe anesthesia and successful surgery. The dynamic is that people do not always arrive early enough to perform the admit functions in a timely manner. The schedule for the day has been predetermined. Operating rooms, clinical staff, instruments and surgeons are all coordinated. If, however, this first step takes too long, the coordination breaks down. The remaining nodes are less amenable to time adjustments.

For example, a surgeon is not likely to perform a procedure five minutes faster to accommodate the late patient. Acute recovery is also unpredictable. To address the fluctuations in timing, architects typically provide additional support space in key areas. This simply increases the cost of the facility without increasing the efficiency. If more support space is built in order to accommodate perceived timing conflicts, it does not address the fundamental poor design of the center. The staff is able to successfully manage the dynamic process and the patient.

The length of time to admit an individual depends on the testing to be done and the education needs. An average range is 15-20 minutes and the size of the waiting area is reduced if a paging system is used to notify sponsors.

II. Pre-Operative Node

The second node of interaction is pre-operative node 14. The location of this area is adjacent to the business and administrative area separated by a corridor.

Pre-operative node 14 is the first clinical space a patient is exposed to. It is important to keep this area neat and clean. Architectural responses with soft lighting and wall finishes are effective. Interesting floor patterns also are effective. The clinical nurse responsible for the patient escorts the patient through the process. Pre-operative node 14 is in the middle of surgery center 10 and provides little or no outside natural lighting. Natural lighting aids a patient's self-orientation, so a glimpse of the sky aids in orientation.

A patient in pre-operative node 14 may have to change into an operative gown. Visual privacy is important. Small changing areas 54 adjacent to a main pre-op room 56 allows patients with minimal procedures to get changed and bypass the bed area via a corridor 58. This is an efficient response to the large percentage of cases that do not require patients to be put on a stretcher. This directly decreases the throughput rate for these patients. It is inefficient to tie up beds and prep areas with minor procedure patients.

Another related architectural response to the minor procedure patient is to provide a minor procedure room. This room is used for minor procedures that do not require significant anesthetics or assistance by staff. A minor procedure room frees up the operating room for more difficult procedures. The room is most effectively located close to the waiting area. Patients can then use the room without excessive circulation. In most cases, the minor procedure patient will not require the use of any post-operative areas. Occasionally there may be a need to use the observation area.

The time to prep patients for surgery is dependent upon the procedure to be performed. In some cases, the surgeon will want to speak with a patient and discuss the procedure. It is important to provide enough room around each bed to accommodate a nurse, physician and anesthesiologist. The minimum needed is 3 feet on either side and at the foot of the bed. A cabinet on the headwall for supplies that is 12″ deep is also provided. Approximately 70 NSF is required if using curtains instead of walls to separate the patient beds. Using hard walls requires approximately 100 NSF.

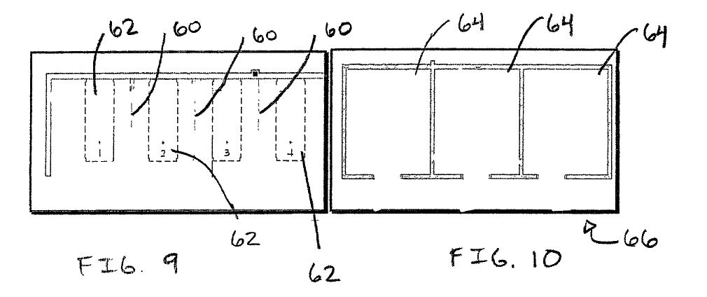

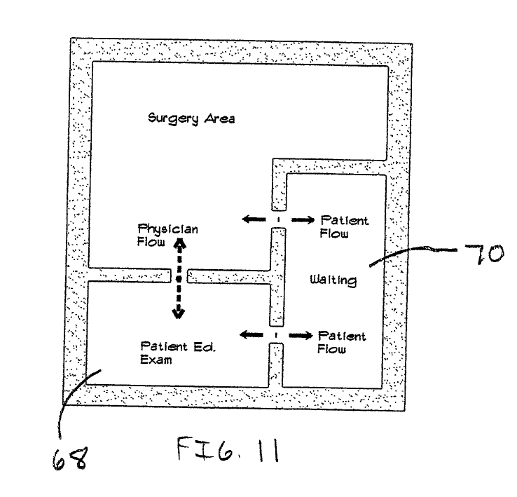

As illustrated in FIGS. 9 and 10, there are generally two methods of layout for the pre-op area. One is a large room with a series of curtains 60 dividing up pre-op beds 62, and the other is separate pre-op rooms 64 within a large pre-op area 66. Curtains 60 in the pre-op area are more efficient, however audible privacy is compromised. Secondly, a large room with curtains, beds and medical gas headwalls looks institutional.

By using individual prep rooms, a patient is not subject to visual overload and audible privacy is easily achieved. The cost for this solution is expensive when compared to the alternative. Individual prep rooms require separate lighting, HVAC and doors, as well as the walls themselves. Another inherent problem with individual prep rooms is reduced efficiency of the nursing staff. It is far more difficult to manage and monitor patients in segregated areas. Central control is also compromised. If physicians are discreet, the audible privacy issue can be minimized. Patients that require considerable discussion can also be staggered.

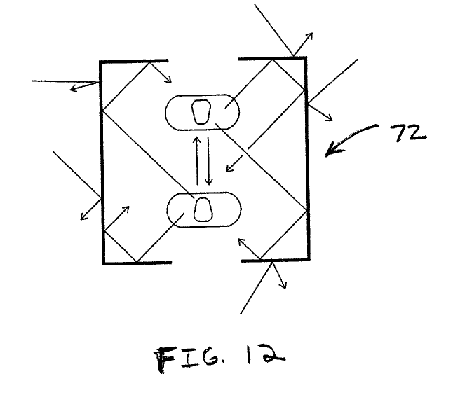

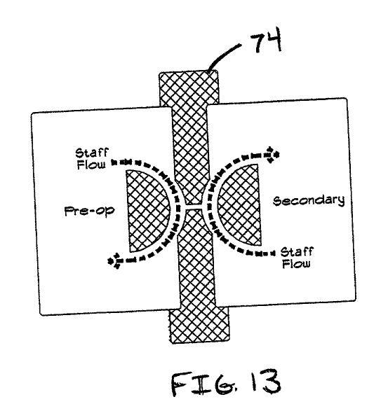

As illustrated in FIGS. 11 and 12, another method of reducing the incidence of eavesdropping between patients is to provide a small conference room adjacent to a waiting area 70. With private access for the anesthesiologist and the physician, a patient is educated and the procedure is discussed in the confines of a small room. This works well as room 68 doubles as an education room for patients considering surgery in advance. The room can further serve as the post-op counseling room. As illustrated in FIG. 12, a small admit cubicle 72 also allows privacy for patients discussing personal information with the staff.

The pre-op bed is sometimes used to begin IV's for patients receiving regional anesthesia. Depending on the anesthesiologist, the patient may begin the anesthetic before entering the surgical suite. This reduces the amount of occupied time in the operating room, thereby using support space to increase the efficiency of the revenue generating operating room.

Supplies for this area are stored in nearly cabinetry and sometimes in a dedicated medicine prep room. These supplies are restocked from the bulk storage room before, during and after each day's activities. Environmental waste is kept in small, designated containers. The containers are kept in designated areas within close proximity to the pre-op room. This reduces the time spent removing waste during operating hours when efficiency is critical. At the end of each day, the waste is relocated to the designated soiled holding room for pickup by the environmental waste service.

As illustrated in FIG. 13, another consideration that affects efficiency is the storage of personal items belonging to the patient. There are generally two accepted methods for storing personal items. Clothing and personal items can be placed in a plastic bag or like container and sent with the patient on the gurney. The second method is to use a set of patient lockers 74. The placement of lockers 74 impacts the efficiency of the center. Lockers 74 are placed between the pre-op area and the step-down recovery area. This minimizes the amount of time the staff needs to place and retrieve the belongings from the lockers. In some cases, pass-thru lockers can be used.

III. Surgical Node

The third node of interaction is surgical node 16. Surgical node 16 is the most complicated and the most important in terms of achieving efficiency in the center. All five major flow patterns intersect at this node and timing is critical. One room can support as many as 1800 cases. As a general rule of thumb, the minimum of 1200 cases annually is used to support a freestanding surgery center.

At the beginning of the surgery day, the room is terminally sterile as a result of the previous day. Throughout a typical day, many procedures will transpire in this room. The number of procedures ranges from a couple to as many as 12 or more in a day. The number of cases depends on the nature of the procedures themselves, and the efficiency of the staff.

Communication is the key to an efficiently run operating suite. The circulating nurse should be able to contact the OR supervisor or nurse supervisor without leaving the room. A utility sink within the sub-sterile area allows the circulating nurse to wash his/her hands before flash sterilizing a solid instrument.

The amount of time it takes the clinical staff to prepare the room between each patient is known as the “room turn-over time”. Ten-minute turn-over times are possible and the rooms should nevertheless be turned over in less than twenty minutes.

At the end of a procedure, the instruments are processed first. They are placed in chemical trays before leaving the operating room. This is done to reduce the incidence of air-borne pathogens. These trays are then taken to the soiled receiving room. A centralized soiled receiving room increases efficiency by reducing the travel time for staff. Instruments are then washed and sterilized for the next procedure. All instruments must be terminally sterilized before being used on another patient. The time it takes to sterilize instruments between cases is known as “tray turn-over time” Tray turn-over time is effectively completed in fifteen minutes. An example of tray turn-over time is back-to-back ACL reconstructions using one ACL tray and performing one ACL procedure each hour. This is difficult using one tray, but it is possible.

Next, the environmental waste is properly packaged and removed from the room. Anything with blood or fluids is considered contaminated or “environmental” waste and is placed in a red bag. Soiled linens are placed in yellow bags. Regular waste, such as wrappers from sterile packaging is placed in a black or white bag. The waste is taken to the soiled holding area to be stored safely until it is picked up.

Once the instruments and the waste are removed, the clinical staff must prepare the room. The floor is cleaned and disinfected. Furniture and equipment is rearranged and all contaminated surfaces in the room are wiped down and disinfected. At this point, new linens are laid, new suction canisters are placed, fluids are brought in and sterile instruments are delivered and arranged. Sterile supplies are opened, the patient is brought in and the process beings again. New instruments and equipment are brought into the room and arranged.

During this turn over time, the surgeon must dictate the procedure, consult the patient's family or the patient, and scrub for the next case. Properly placed scrub sinks with access windows into the operating room allows a surgeon to simultaneously scrub while viewing the operating room as it is prepped. The surgeon is now ready for the next patient. The room is ready, the patient is brought in and the process beings again.

For example, at the tope of the hour, assume anesthesia is delivered. Within a few minutes, the tourniquet is applied and the surgeon begins the procedure. A fast surgeon performs this procedure in 42 minutes. At about 45 minutes elapsed time, the surgeon dictates the procedure as the patient is taken to recovery. The instruments and waste are removed. The surgeon discusses the particulars of the procedure with family members. On the way back to the OR, the surgeon may briefly check on the patient. The surgeon scrubs and is prepared for the next ACL which begins at the top of the hour. This allows for a 15 minute turn-over time. A room should take no more than 20 minutes to turn over. One surgeon could therefore perform as many as 8 of these procedures in a single day. It takes practice to achieve this level of efficiency and key personnel must concert their efforts to maximize efficiency.

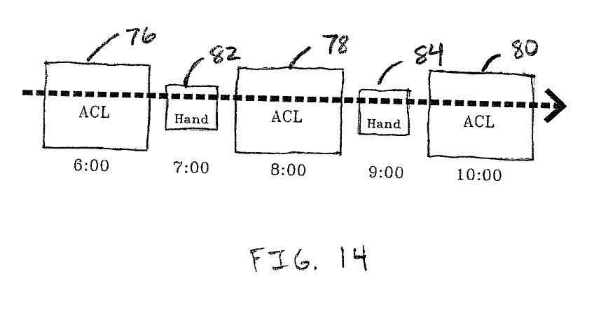

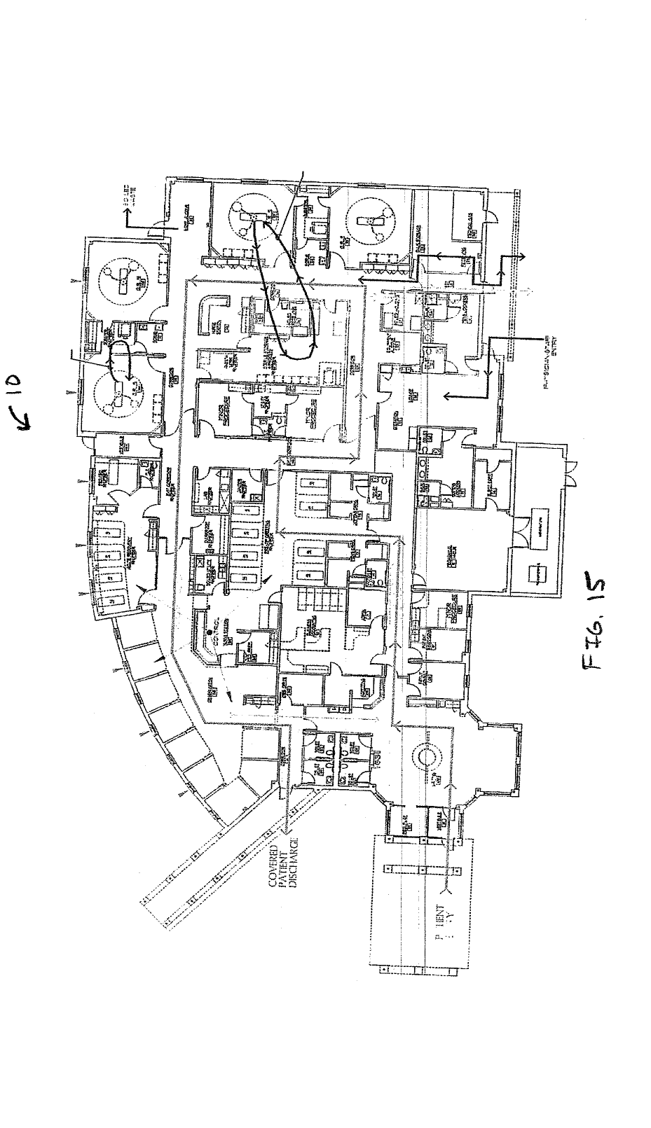

Another factor that will increase efficiency of the center is the selection and volume of instruments. As illustrated in FIG. 14, it is difficult to achieve one-hour turnover rates with a single ACL tray. Two ACL trays would probably ensure one-hour turnovers. The problem is that these trays are expensive. A good scheduler will alternate procedures to utilize a single set of instrument trays. For example, a first ACL procedure 76, a second ACL procedure 78 and a third ACL procedure 80 separated by a first hand procedure 82 and a second hand procedure 84 is a good use of instruments.

An event that occurs during a procedure that requires special attention is the mishap of a soiled instrument. Inevitably, instruments fall on the floor or sometimes come into contact with soiled materials. A good circulation nurse will monitor the sterile zone looking for compromises in the environment. A dropped instrument can be flash sterilized and used again for the same procedure on the same patient. Having a flash sterilizer adjacent to the operating room is an effective way to maintain a good throughput rate of patients. Considerable time is saved by not having to soak the instrument and walk across the hall to the soiled receiving room.

IV. Acute Recovery Node

The fourth node of interaction is acute recovery node 18. Acute recovery is the first of two stages of recovery. Acute recovery refers to emergence from general and local anesthetic and sedative drugs. This is where the patient regains consciousness, airway reflexes and motor activity.

Acute recovery node 18 is preferably located immediately adjacent to surgical node 16, and just between surgical node 16 and observation node 20. The reasons for this include that the transition from surgery to recovery is the area where most patients will crash or code. Another important factor is the need to have an anesthesiologist close at hand in the event a patient needs help in recovery. The anesthesiologist and the recovery personnel must be encouraged to communicate. The anesthesiologist begins by detailing and relaying any specific concerns or problems intraoperatively to the recovery personnel along with an anticipated recovery course.

The anesthesiologist is best accommodated if an anesthesia workroom is located adjacent to the acute recovery. This allows the anesthesiologist to be within close proximity of the surgical suite and the postoperative patient.

The space requirements for acute recovery node 18 are similar to pre-op (three feet on either side and at the foot of the bed). The ratio of operating rooms to beds is a range between 1:1.25 and 1:1.6. The final number depends on specific caseload analysis. The actual configuration is open with curtains. It is also preferable to provide an isolation room in acute recovery. This room provides an added level of flexibility for the acute recovery staff. The room is used for pediatrics or problematic patients emerging from anesthesia. It also provides a private room to discuss sensitive matters.

One of the most important architectural components in acute recovery is natural light. The natural light aids in orientation and emergence from general anesthesia. Windows and skylights are both effective. If windows are provided, consideration should be given to the height of the sill. If the sill height is 5′-0″ above the floor, a medical gas headwall with shelves for monitors can be placed below for a good use of vertical space.

V. Observation Node

Not all patients require acute recovery node 18. Many ambulatory patients can recover nicely in a recliner. It is best to segregate acute recovery node 18 from step-down recovery. If possible, it is more efficient if ambulating patients can bypass acute recovery node 18 and go directly into observation node 20 (e.g., step-down recovery area). A bypass corridor decreases patient throughput rate for ambulatory patients, and increases overall center efficiency.

Observation node 20 is the last interaction between patient and staff. This is the area of discharge. This is the area that family members join the patients. The area a series of bays separated by curtains or walls. With a recliner or a sitting chair, the patient can converse comfortably with family, staff and physicians. It is important to maintain much visual control, however, from the nurse station. Plenty of natural light is also needed. Patients also have access to toilets and nourishment. Whether or not a patient can eat, drink and void ultimately determines the discharge status of the patient.

If unidirectional patient flow 26 is used, the patient in observation node 20 is now adjacent to admit/reception node 12. The last and final component is the discharge canopy. Providing a separate discharge for outgoing patients allows postoperative patient to maintain a significant amount of dignity. It is a poor design that requires a postoperative patient to transcend the waiting room to be scrutinized by waiting sponsors.

Understanding the interaction between staff and patients is paramount to the design of the surgery center. As discussed, the functions and operations at and around each node have an impact on the layout of the facility. A lack of understanding of these concepts results in inefficient building plans. What the surgeon does is critical to the flow of the center. What each staff member contributes is equally important. The concept of an efficient plan is designing physical space that promotes efficient operations.

As illustrated in FIG. 15, there are five major flow patterns that are examined for their contribution to the whole and integrated with circumspect precision. Patient flow 26 is identified first and integrated with the remaining four patterns 28, 32, 34 and 36. The surgical specialty determines the room sizes and configuration, but the primary flow patterns 26, 28, 32, 34 and 36 and functional relationships remain the same. Therefore, a unidirectional patient flow is created with the placement of nodes 12, 14, 16, 18 and 20 given the flow patterns 26, 28, 32, 34 and 36 to determine the efficiency of surgical center 10.

The scope of the application is not to be limited by the description of the preferred embodiments described above, but is to be limited solely by the scope of the claims that follow.

What is claimed is:

1. A surgery center comprising:
an admit/reception node;
a pre-operative node located adjacent the admit/reception node;
a surgical node located adjacent the pre-operative node;
an acute recovery node located adjacent to the surgical node;
an observation node, wherein the acute recovery node is located between the surgical node and the observation node; and
wherein a patient flow throughout each of the nodes is unidirectional, an instrument flow is circular and confined to the surgical node, a staff/physician flow includes a separate entry to the surgery center separate from the admit/reception node and the observation node, a supply flow is linear, and an environmental waste flow includes transitioning between a sterile zone and a non-sterile zone.

2. The surgery center according to claim 1, wherein the pre-operative node is located adjacent to a business area that is separated by a corridor.

3. The surgery center according to claim 1, wherein a set of changing areas is provided adjacent to the pre-operative node.

4. The surgery center according to claim 1, wherein the pre-operative node is a large room with a series of curtains dividing a set of pre-op beds.

5. The surgery center according to claim 1, wherein the pre-operative node is a series of separate pre-op rooms within a single pre-op area.

6. The surgery center according to claim 1, wherein a conference room is provided adjacent to the pre-operative node.

7. The surgery center according to claim 1, wherein the patient flow, the instrument flow, the staff/physician flow, the supply flow and the environmental waste flow intersect at the surgical node.

8. The surgery center according to claim 1, wherein the observation node includes a series of bays separated by a set of curtains.

9. The surgery center according to claim 1, wherein the observation node includes a series of bays separated by a set of walls.

10. The surgery center according to claim 1, wherein a discharge canopy is provided adjacent the observation node.

11. The surgery center according to claim 1, wherein a supply/utility room is adjacent the pre-operative node and the acute recovery node simultaneously.

12. The surgery center according to claim 1, wherein the supply flow includes transitioning between the sterile zone and the non-sterile zone.

13. A surgery center comprising:
an admit/reception node;
a pre-operative node located adjacent the admit/reception node;
a surgical node located adjacent the pre-operative node;
an acute recovery node located adjacent to the surgical node;
an observation node, wherein the acute recovery node is located between the surgical node and the observation node; and
wherein a patient flow throughout each of the nodes is unidirectional.

14. The surgery center according to claim 13, wherein an instrument flow is circular and confined to the surgical node, a staff/physician flow includes a separate entry to the surgery center separate from the admit/reception node and the observation node, a supply flow is linear, and an environmental waste flow includes transitioning between a sterile zone and a non-sterile zone.

15. The surgery center according to claim 13, wherein a conference room is provided adjacent to the pre-operative node.

16. The surgery center according to claim 13, wherein the patient flow, the instrument flow, the staff/physician flow, the supply flow and the environmental waste flow intersect at the surgical node.

17. A surgery center comprising:
an admit/reception node;
a pre-operative node located adjacent the admit/reception node;
a surgical node located adjacent the pre-operative node;
an acute recovery node located adjacent to the surgical node;
an observation node, wherein the acute recovery node is located between the surgical node and the observation node;
wherein a patient flow throughout each of the nodes is unidirectional, an instrument flow is circular and confined to the surgical node, a staff/physician flow includes a separate entry to the surgery center separate from the admit/reception node and the observation node, a supply flow is linear, an environmental waste flow includes transitioning between a sterile zone and a non-sterile zone; and
wherein the patient flow, the instrument flow, the staff/physician flow, the supply flow and the environmental waste flow intersect at the surgical node.

18. The surgery center according to claim 17, wherein a supply/utility room is adjacent the pre-operative node and the acute recovery node simultaneously.

19. The surgery center according to claim 17, wherein the supply flow includes transitioning between the sterile zone and the non-sterile zone.

20. The surgery center according to claim 17, wherein a conference room is provided adjacent to the pre-operative node.
